(19) United States
(12) Patent Application Publication
(10) Pub. No.: US 2013/0157070 A1
(43) Pub. Date: Jun. 20, 2013

(54) CONDUCTIVE FILM AND CONDUCTIVE FILM ROLL

(71) Applicant: Nitto Denko Corporation, Osaka (JP)

(72) Inventors: Nozomi Fujino, Osaka (JP); Hiroyuki Takao, Osaka (JP); Kuniaki Ishibashi, Osaka (JP)

(73) Assignee: NITTO DENKO CORPORATION, Osaka (JP)

(21) Appl. No.: 13/716,403

(22) Filed: Dec. 17, 2012

(30) Foreign Application Priority Data
Dec. 20, 2011 (JP) 2011-278347

(51) Int. Cl. H01B 7/04

(52) U.S. Cl. CPC H01B 7/04
USPC 428/469

(57) ABSTRACT

A conductive film which comprises: a film substrate; a first transparent conductor layer; a first metal layer; and a nitride coated layer, the first transparent conductor layer, the first metal layer, and the nitride coated layer being laminated on one surface of the film substrate; a second transparent conductor layer; and a second metal layer, the second transparent conductor layer and the second metal layer are laminated on the other surface of the film substrate. The nitride coated layer prevents blocking of overlapped portions of the conductive film.

### BACKGROUND OF THE INVENTION

1. Field of the Invention

The present invention relates to a conductive film and a conductive film roll.

2. Description of Related Art

A conventional conductive film which comprises: a film substrate; a plurality of transparent conductor layers formed on both surfaces of the film substrate; and a plurality of metal layers formed on respective surfaces of the transparent conductor layers (for example, JPA-2011-60146) is known. Such a conductive film is capable of forming wiring at an outer edge of a touch input region and achieving a narrow frame by etching the metal layers and the transparent conductor layers, for example, when the conductive film is used for a touch panel. However, in the case where both surfaces of the conductive film respectively have a metal layer, there is a problem of blocking of adjacent metal layers in the conductive film when the conductive film is rolled up to obtain a conductive film roll. Blocking is to adhere by pressure.

### SUMMARY OF THE INVENTION

It is an object of the present invention to solve a problem of blocking of adjacent metal layers in a conductive film which arises in a conductive film roll.

The summary of the present invention is described as below.

In a first preferred aspect, a conductive film according to the present invention comprises: a film substrate; a first transparent conductor layer laminated on one surface of the film substrate; and a first metal layer laminated on the first transparent conductor layer; and a nitride coated layer laminated on the first metal layer. The conductive film according to the present invention further comprises: a second transparent conductor layer laminated on the other surface of the film substrate; and a second metal layer laminated on the second transparent conductor layer.

In a second preferred aspect of the conductive film according to the present invention, the first and second metal layers are respectively a copper layer and the nitride coated layer contains copper nitride.

In a third preferred aspect of the conductive film according to the present invention, the nitride coated layer has a copper nitride content of 50% by weight to 100% by weight.

In a fourth preferred aspect of the conductive film according to the present invention, each material for forming the first and second transparent conductor layers is any one of indium tin oxide (ITO), indium zinc oxide or indium oxide-zinc composite oxide.

In a fifth preferred aspect, a conductive film according to the present invention comprises: a film substrate; a first transparent conductor layer laminated on one surface of the film substrate; a first metal layer laminated on the first transparent conductor layer; and a first nitride coated layer laminated on the first metal layer. The conductive film according to the present invention further comprises: a second transparent conductor layer laminated on the other surface of the film substrate; a second metal layer laminated on the second transparent conductor layer; a second nitride coated layer laminated on the second metal layer.

In a sixth preferred aspect of the conductive film according to the present invention, the first and second metal layers are respectively a copper layer and the first and second nitride coated layers respectively contain copper nitride.

In a seventh preferred aspect of the conductive film according to the present invention, the first nitride coated layer has a copper nitride content of 50% by weight to 100% by weight and the second nitride coated layer has a copper nitride content of 50% by weight to 100% by weight.

In an eighth preferred aspect of the conductive film according to the present invention, each material for forming the first and second transparent conductor layers is any one of indium tin oxide (ITO), indium zinc oxide or indium oxide-zinc composite oxide.

In another preferred aspect, a conductive film roll according to the present invention is obtained by rolling up the conductive film.

### ADVANTAGE OF THE INVENTION

According to the present invention, it is possible to solve a problem of blocking of metal layers in a conductive film roll.

### BRIEF DESCRIPTION OF THE DRAWINGS

FIG. 1 is a cross-sectional schematic view of a conductive film (first embodiment) of the present invention;

FIG. 2 is a cross-sectional schematic view of a conductive film roll (first embodiment) of the present invention;

FIG. 3 is a cross-sectional schematic view of a conductive film (second embodiment) of the present invention; and

FIG. 4 is a cross-sectional schematic view of a conductive film roll (second embodiment) of the present invention.

### DESCRIPTION OF THE PREFERRED EMBODIMENTS

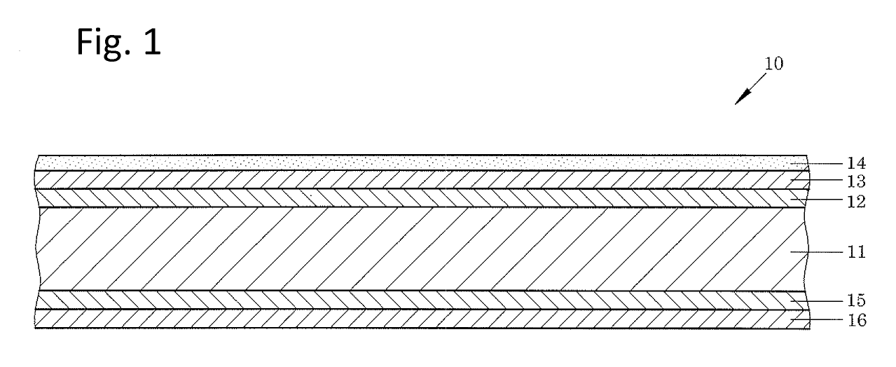

The preferred embodiments of the present invention will now be described with reference to FIGS. 1 to 4. Identical elements in the figure are designated with the same reference numerals.

### [Conductive Film]

As shown in FIG. 1, a conductive film 10 (first embodiment) of the present invention comprises: a film substrate 11; a first transparent conductor layer 12; and a first metal layer 13; a nitride coated layer 14; a second transparent conductor layer 15; and a second metal layer 16. The first transparent conductor layer 12, the first metal layer 13, and the nitride coated layer 14 are laminated on one surface of the film substrate 11 (the top surface in FIG. 1) in this order. The second transparent conductor layer 15 and the second metal layer 16 are laminated on the other surface of the film substrate 11 (the bottom surface in FIG. 1) in this order.

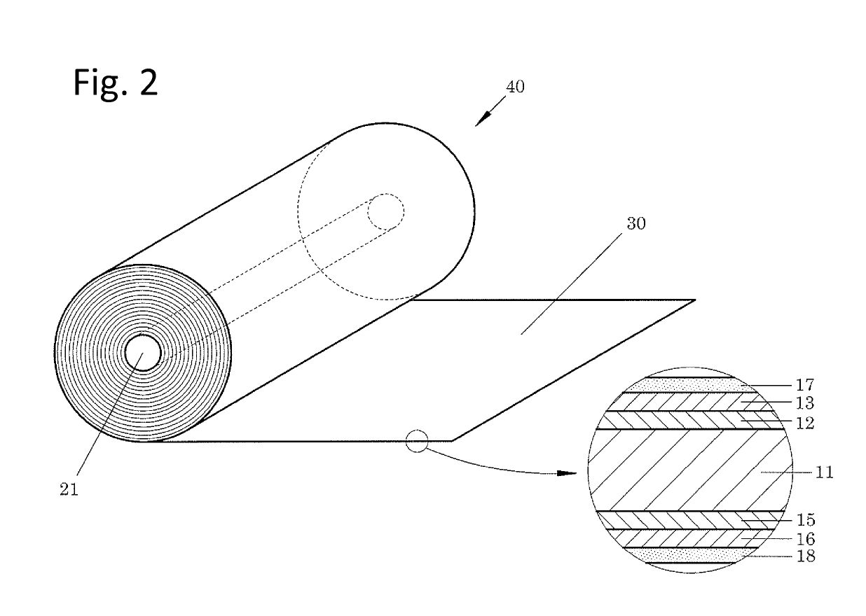

As shown in FIG. 2, a conductive film roll 20 (first embodiment) of the present invention is obtained by rolling up an elongated conductive film 10 of the present invention. The conductive film 10 typically has a length of 100 m or more, preferably 500 m to 5,000 m. A rolled core 21 made of plastic or metal to be wound around by the conductive film 10 is generally placed in the central portion of the conductive film roll 20.

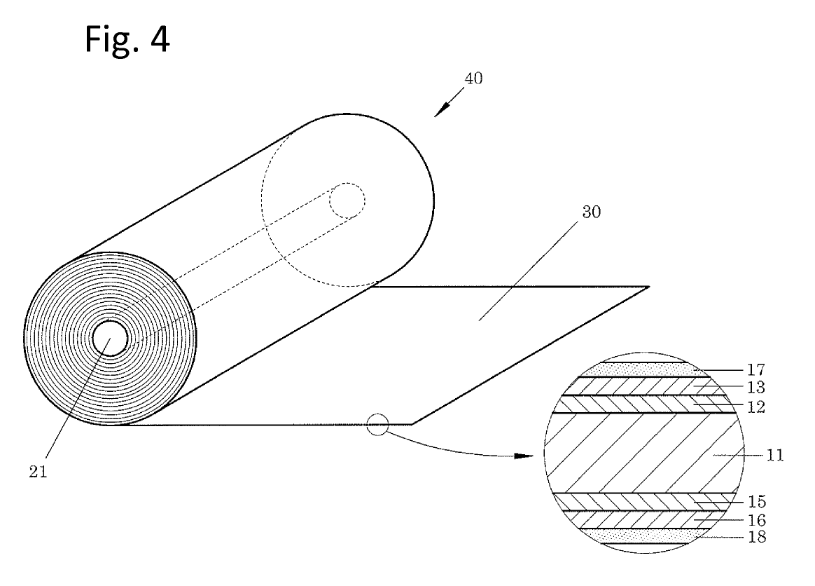

As shown in FIG. 3, a conductive film 30 (second embodiment) of the present invention comprises: a film substrate 11; a first transparent conductor layer 12; and a first metal layer 13; a first nitride coated layer 17; a second transparent conductor layer 15; a second metal layer 16; and a second nitride coated layer 18. The first transparent conductor layer 12, the first metal layer 13, and the first nitride coated layer 17 are laminated on one surface (the top surface in FIG. 3) of the film substrate 11 in this order. The second transparent conductor layer 15, the second metal layer 16, and the second nitride coated layer 18 are laminated on the other surface (the bottom surface in FIG. 3) of the film substrate 11 in this order.

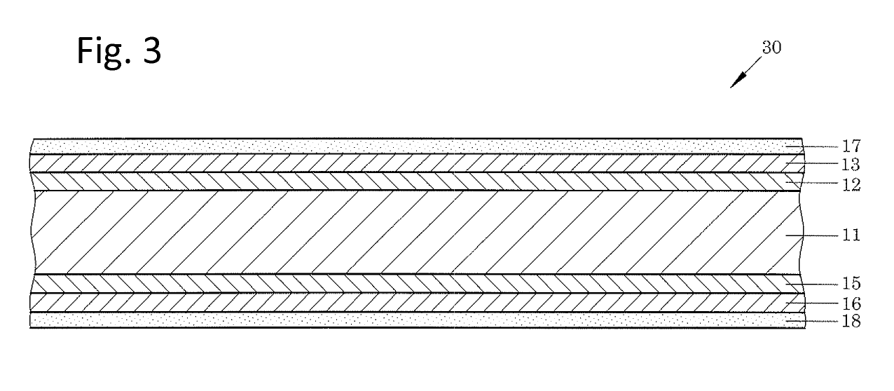

As shown in FIG. 4, a conductive film roll 40 (second embodiment) of the present invention is obtained by rolling up an elongated conductive film 30 of the present invention. The conductive film 30 typically has a length of 100 m or more, preferably 500 m to 5,000 m. A rolled core 21 made of plastic or metal to be wound around by the conductive film 30 is generally placed in the central portion of the conductive film roll 40.

In the conductive film 10 (FIG. 1) of the present invention, it is possible to avoid blocking of the first metal layer 13 and the second metal layer 16 by forming the nitride coated layer 14 on a surface of the first metal layer 13 when the conductive film roll 20 is obtained by rolling up the conductive film 10. Accordingly, when the conductive film roll 20 (FIG. 2) is obtained by rolling up the conductive film 10, it is not needed to insert a slip sheet into the conductive film 10.

In the conductive film 30 (FIG. 3) of the present invention, it is possible to avoid blocking of the first metal layer 13 and the second metal layer 16 by forming the first nitride coated layer 17 on a surface of the first metal layer 13 and forming the second nitride coated layer 18 on a surface of the second metal layer 16 when the conductive film roll 40 (FIG. 4) is obtained by rolling up the conductive film 30. Accordingly, when the conductive film roll 40 is obtained by rolling up the conductive film 30, it is not needed to insert a slip sheet into the conductive film 30. While a nitride coated layer is formed on one surface of the conductive film 10 (first embodiment) (FIG. 1) of the present invention, a nitride coated layer is formed on each surface of the conductive film 30 (second embodiment) (FIG. 3). In the conductive film 10 (first embodiment) (FIG. 1), when the forming of the nitride coated layer 14 is locally imperfect, it is impossible to deny the possibility of blocking. On the other hand, in the conductive film 30 (second embodiment) (FIG. 3) of the present invention, even when the formation of the first nitride coated layer 17 or the second nitride coated layer 18 is locally imperfect, when the conductive film roll 40 is obtained, there is an extremely low possibility that an imperfect portion in the formation of the first nitride coated layer 17 may coincide with an imperfect portion in the formation of the second nitride coated layer 18. Accordingly, there is substantially no possibility that blocking may occur in the conductive film roll 40. However, it would cost higher to form a nitride coated layer respectively on both surfaces than to form a nitride coated layer on one surface. As a result, it is decided whether a nitride coated layer is formed respectively on both surfaces or a nitride coated layer is formed on one surface as a result of comparison between the costs and the occurrence percentage of the blocking.

When the conductive film 10 (FIG. 1) is rolled up to obtain a conductive film roll 20 (FIG. 2), the reason why the nitride coated layer 14 prevents the blocking of the first metal layer 13 and the second metal layer 16 is presumed as below. The first metal layer 13 and the second metal layer 16 are prevented from being metallically bound to each other because the nitride coated layer 14 (typically nitride copper layer) without free electron is interposed between the first metal layer 13 and the second metal layer 16 arranged adjacently.

When the conductive film 30 (FIG. 3) is rolled up to obtain a conductive film roll 40 (FIG. 4), the reason why the first nitride coated layer 17 and the second nitride coated layer 18 prevent the blocking of the first metal layer 13 and the second metal layer 16 is presumed as below. The first metal layer 13 and the second metal layer 16 are prevented from being metallically bound to each other because the first nitride coated layer 17 (typically nitride copper layer) without free electron and the second nitride coated layer 18 (typically nitride copper layer) without free electron are interposed between the first metal layer 13 and the second metal layer 16 arranged adjacently.

### [Film Substrate]

The film substrate 11 (FIG. 1, FIG. 3) supports the first transparent conductor layer 12 and the second transparent conductor layer 15. The film substrate 11 typically has a thickness of 20 μm to 200 μm. A material for forming the film substrate 11 is preferably polyethylene terephthalate, polycycloolefin or polycarbobnate. The film substrate 11 may have an easily adhering layer (not shown) to increase adhesion of the film substrate 11 and the first transparent conductor layer 12, an easily adhering layer (not shown) to increase adhesion of the film substrate 11 and the second transparent conductor layer 15, an index-matching layer (not shown) to adjust the refractive index of the film substrate 11, and a hard coating layer (not shown) to prevent surfaces of the film substrate 11 from being scratched.

### [Transparent Conductor Layer]

The first transparent conductor layer 12 (FIG. 1, FIG. 3) is formed on one surface of the film substrate 11. The first transparent conductor layer 12 is composed of a transparent conductor. The second transparent conductor layer 15 (FIG. 1, FIG. 3) is formed on the other surface of the film substrate 11. The second transparent conductor layer 15 is composed of a transparent conductor. A material for a transparent conductor having a high transmittance in a visible light region and a low surface resistance value per unit area is used. The maximum transmittance in the visible light region is typically 80% or higher. The surface resistance value per unit area is typically 500Ω per square or lower.

A material for forming the first transparent conductor layer 12 (FIG. 1, FIG. 3) is preferably made of any one of indium tin oxide (ITO), indium zinc-oxide or indium oxide-zinc oxide composite oxide. A material for forming the second transparent conductor layer 15 (FIG. 1, FIG. 3) is the same as the above. The first transparent conductor layer 12 preferably has a thickness of 15 nm to 80 nm. The thickness of the second transparent conductor layer 15 is the same as that of the first transparent conductor layer 12.

### [Metal Layer]

The first metal layer 13 (FIG. 1, FIG. 3) is formed on a surface of the first transparent conductor layer 12. While a material for forming the first metal layer 13 is preferably copper, the material is not limited to copper. The second metal layer 16 (FIG. 1, FIG. 3) to be used in the present invention is formed on a surface of the second transparent conductor layer 15. While a material for the second metal layer 16 is preferably copper, the material is not limited to copper. When the film substrate 11 is typically used for a touch panel, the first metal layer 13 is used to form wirings outside a touch input region by etching the first metal layer 13 and the first transparent conductor layer 12. The uses of the second metal layer 16 are the same as those of the first metal layer 13.

The first metal layer 13 (FIG. 1, FIG. 3) preferably has a thickness of 20 nm to 300 nm, more preferably 25 nm to 250 nm. It is possible to reduce the width of the wirings to be formed by limiting the thickness of the first metal layer 13 within this range. The thickness of the second metal layer 16 (FIG. 1, FIG. 3) is the same as that of the first metal layer 13.

### [Nitride Coated Layer]

The nitride coated layer 14 (FIG. 1) is formed on a surface of the first metal layer 13. The nitride coated layer 14 is preferably formed before surfaces of the metal Layer 13 become oxidized. In the case where the material for the first metal layer 13 is copper, the nitride coated layer 14 contains copper nitride (Cu₃N). The nitride coated layer 14 preferably has a cooper nitride content of 50% by weight to 100% by weight, more preferably 60% by weight to 100% by weight. The nitride coated layer 14 may consist of copper nitride only. Alternatively, the nitride coated layer 14 may contain copper (not nitrided), copper oxide, copper carbonate, copper hydroxide or the like in addition to nitride copper.

The nitride coated layer 14 (FIG. 1) preferably has a thickness of 1 nm to 15 nm, more preferably has a thickness of 1 nm to 8 nm. It is possible to effectively prevent the blocking of the first metal layer 13 and the second metal layer 16 by setting the thickness of the nitride coated layer 14 at 1 nm or greater. When the thickness of the nitride coated layer 14 is greater than necessary, there are fears that productivity of the nitride coated layer 14 may be lowered.

The first nitride coated layer 17 (FIG. 3) is formed on a surface of the first metal layer 13. The first nitride coated layer 17 is preferably formed before the surface of the first metal layer 13 is oxidized. The second nitride coated layer 18 (FIG. 3) is formed on a surface of the second metal layer 16. The second nitride coated layer 18 is preferably formed before the surface of the second metal layer 16 is oxidized. The material, the composition, and the thickness of the first nitride coated layer 17 are the same as those of the nitride coated layer 14 (FIG. 1). The material, the composition, and the thickness of the second nitride coated layer 18 are the same as those of the nitride coated layer 14 (FIG. 1).

### [Manufacturing Method]

A method for manufacturing a conductive film 10 (FIG. 1) of the present invention will now be described below. Firstly, a roll of a film substrate 11 typically having a length of 500 m to 5,000 m is set in a sputtering apparatus not illustrated. Secondly, a first transparent conductor layer 12 and a first metal layer 13, and a nitride coated layer 14 are sequentially formed on one surface of the film substrate 11 by the sputtering method while conveying the film substrate 11. Thirdly, a second transparent conductor layer 15 and a second metal layer 16 are sequentially formed on the other surface of the film substrate 11 by the sputtering method.

A method for manufacturing a conductive film 30 (FIG. 3) of the present invention will now be described below. Firstly, a roll of a film substrate 11 typically having a length of 500 m to 5,000 m is set in a sputtering apparatus not illustrated. Secondly, a first transparent conductor layer 12 and a first metal layer 13, and a first nitride coated layer 17 are sequentially formed on one surface of the film substrate 11 by the sputtering method while conveying the film substrate 11. Thirdly, a second transparent conductor layer 15, a second metal layer 16, and a second nitride coated layer 18 are sequentially formed on the other surface of the film substrate 11 by the sputtering method.

In the sputtering method, cation in plasma generated in a low-pressure gas is caused to collide with a target material (negative electrode) to attach a constituent for the target material scattering from a surface of the target material to the film substrate 11. A sintering body target made of indium oxide and tin oxide is used for forming an indium tin oxide (ITO) layer. An oxygen-free copper target is used for forming copper layers (the first metal layer 13, the second metal layer 16). A nitride copper target is used for forming nitride copper layers (the nitride coated layer 14, the first nitride coated layer 17, and the second nitride coated layer 18). Alternatively, sputtering is performed in the presence of a nitride gas using an oxygen-free copper target in forming nitride copper layers (the nitride coated layer 14, the first nitride coated layer 17, and the second nitride coated layer 18).

### EXAMPLES

### Example 1 (FIG. 1)

A first transparent conductor layer 12, a first metal layer 13, and a nitride coated layer 14 were sequentially formed on one surface of a film substrate 11 by the sputtering method. The film substrate 11 was a polycycloolefin film with a length of 1,000 m and a thickness of 100 μm (“ZEONER” (trademark) produced by ZEON CORPORATION). The first transparent conductor layer 12 was an indium tin oxide layer with a thickness of 20 nm. The first metal layer 13 was a copper layer with a thickness of 50 nm. The nitride coated layer 14 was a nitride coated layer containing 70% by weight of nitride copper and having a thickness of 2.5 nm. Subsequently, a second transparent conductor layer 15 and a second metal layer 16 were sequentially formed on one surface of the film substrate 11 by the sputtering method. The second transparent conductor layer 15 was an indium tin oxide layer with a thickness of 30 nm. The second metal layer 16 was a copper layer with a thickness of 50 nm. An obtained conductive film 10 is wound around a rolled core 21 made of plastic to prepare a conductive film roll 20 (FIG. 2). Table 1 shows evaluation results of blocking of overlapped portions in the conductive film roll 20 (FIG. 2) in Example 1.

### Example 2 (FIG. 1)

The thickness of the nitride coated layer 14 was changed to 1.8 nm by the change of sputtering time. A conductive film roll 20 (FIG. 2) was prepared in the same manner as in Example 1 except for that. Table 1 shows evaluation results of blocking of overlapped portions in the conductive film roll 20 (FIG. 2) in Example 2.

### Example 3 (FIG. 1)

The thickness of the nitride coated layer 14 was changed to 5 nm by the change of sputtering time. A conductive film roll 20 (FIG. 2) was prepared in the same manner as in Example 1 except for that. Table 1 shows evaluation results of blocking of overlapped portions in the conductive film roll 20 (FIG. 2) in Example 3.

### Comparative Example

A conductive film roll was prepared in the same manner as in Example 1 except that a nitride coated layer was not formed. Table 1 shows evaluation results of blocking of overlapped portions in the conductive film roll in Comparative Example.

TABLE 1

| | Thickness of a nitride | |
|---|---|---|
| | coated layer | Blocking |
| Example 1 | 2.5 nm | No |
| Example 2 | 1.8 nm | No |
| Example 3 | 5.0 nm | No |
| Comparative Example | No nitride coated layer | Yes |

### [Measuring Method]

### [Thickness of Nitride Coated Layer, Nitride Copper Content]

The thickness of the nitride coated layer and the nitride copper content were measured using an X-ray Photoelectron Spectroscopy Analyzer (Product name: QuanteraSXH produced by ULVAC-PHI INCORPORATED).

### [Blocking Property of Conductive Film Roll]

The conductive film was rewound from the conductive film roll and the surface of the conductive film was observed to confirm whether or not there is blocking. In the case where blocking occurs, peeling sound is made at the time when rewinding and a large number of scratches are generated on the surface of the transparent conductor layer.

### INDUSTRIAL APPLICABILITY

Although the application of the conductive film of the present invention is not limited, the conductive film of the present invention can be preferably used in a capacitance-type touch panel.

This application claims priority from Japanese Patent Application No. 2011-278347, which is incorporated herein by reference.

There have thus been shown and described a novel conductive film and a conductive film roll which fulfill all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A conductive film comprising:
a film substrate;
a first transparent conductor layer laminated on one surface of the film substrate;
a first metal layer laminated on the first transparent conductor layer;
a nitride coated layer laminated on the first metal layer;
a second transparent conductor layer laminated on the other surface of the film substrate; and
a second metal layer laminated on the second transparent conductor layer.

2. The conductive film according to claim 1, wherein the first and second metal layers are respectively a copper layer and the nitride coated layer contains copper nitride.

3. The conductive film according to claim 2, wherein the nitride coated layer has a copper nitride content of 50% by weight to 100% by weight.

4. The conductive film according to claim 1, wherein each material for forming the first and second transparent conductor layers is any one of indium tin oxide (ITO), indium zinc oxide or indium oxide-zinc composite oxide.

5. A conductive film comprising:
a film substrate;
a first transparent conductor layer laminated on one surface of the film substrate;
a first metal layer laminated on the first transparent conductor layer;
a first nitride coated layer laminated on the first metal layer;
a second transparent conductor layer laminated on the other surface of the film substrate;
a second metal layer laminated on the second transparent conductor layer; and
a second nitride coated layer laminated on the second metal layer.

6. The conductive film according to claim 5, wherein the first and second metal layers are respectively a copper layer and the first and second nitride coated layers respectively contain copper nitride.

7. The conductive film according to claim 6, wherein the first nitride coated layer has a copper nitride content of 50% by weight to 100% by weight and the second nitride coated layer has a copper nitride content of 50% by weight to 100% by weight.

8. The conductive film according to claim 5, wherein each material for forming the first and second transparent conductor layers is any one of indium tin oxide (ITO), indium zinc oxide or indium oxide-zinc composite oxide.

9. A conductive film roll obtained by rolling up the conductive film according to claim 1.

10. A conductive film roll obtained by rolling up the conductive film according to claim 2.

11. A conductive film roll obtained by rolling up the conductive film according to claim 3.

12. A conductive film roll obtained by rolling up the conductive film according to claim 4.

13. A conductive film roll obtained by rolling up the conductive film according to claim 5.

14. A conductive film roll obtained by rolling up the conductive film according to claim 6.

15. A conductive film roll obtained by rolling up the conductive film according to claim 7.

16. A conductive film roll obtained by rolling up the conductive film according to claim 8.
